(19) United States
(12) Patent Application Publication
(10) Pub. No.: US 2009/0280976 A1
(43) Pub. Date: Nov. 12, 2009

(54) Method for manufacturing catalyst layer of membrane electrode assembly

(75) Inventor: Ki Sub Lee, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/288,792

(22) Filed: Oct. 23, 2008

(30) Foreign Application Priority Data
May 6, 2008 (KR) 10-2008-0041651

(51) Int. Cl. H01M 4/88

(52) U.S. Cl. 502/101

(57) ABSTRACT

The present invention relates to a method for manufacturing catalyst layer of membrane electrode assembly MEA. More particularly, the present invention relates to a method manufacturing for catalyst layer of MEA, which can improve performance of the MEA by separating the two substances that consist of the catalyst layer according to the density differences.

### CROSS-REFERENCE TO RELATED APPLICATION

This application claims under 35 U.S.C. §119(a) the benefit of Korean Patent Application No. 10-2008-0041651 filed May 6, 2008, the entire contents of which are incorporated herein by reference.

### BACKGROUND

(a) Technical Field

The present invention relates to a method for manufacturing a catalyst layer of a membrane electrode assembly (“MEA”). More particularly, the present invention relates to a method of manufacturing a catalyst layer of a MEA, which can improve performance of the MEA by separating the two substances that consist of the catalyst layer according to the density differences.

(b) Background Art

A catalyst layer of a membrane electrode assembly (“MEA”) for a fuel cell is typically composed of ionomer binder, through which hydrogen ions pass, and catalyst carried by carbon. FIG. 1 is a schematic diagram illustrating an exemplary structure of a conventional fuel cell MEA. FIG. 2 is a schematic diagram illustrating an exemplary structure of a catalyst layer of an MEA manufactured by a conventional method.

As illustrated in FIG. 1, in the structure of the MEA for the fuel cell, the catalyst layers 4 are preferably disposed at both sides of an ion exchange layer 3. A gas diffusion layer 5 and a separate plate 6 are preferably disposed sequentially away from each catalyst layer 4.

Preferably, in a cathode of the MEA, hydrogen gas enters through a channel 7 formed on the separate plate 6, and moves toward the catalyst layer 4 through the gas diffusion layer 5. The gas flowed into the cathode moves to an interface between the gas diffusion layer 5 and the catalyst layer 4, i.e. a catalyst layer interface 1, and then the gas reacts with the catalyst and is disassociated into hydrogen ions and electrons.

The hydrogen ions pass through an interface between the catalyst layer 4 and the ion exchange layer 3, i.e. an ion exchange layer interface 2, via the catalyst layer 4, and pass through the ion exchange layer 3.

The hydrogen is suitably transferred to the catalyst layer interface 1 in a state of gas, and afterward is transferred in a state of ion. Thus, in order to improve the performance of the MEA, it is preferable to configure a portion of the catalyst layer adjacent to the gas diffusion layer to have low density of the ionomer binder with sufficient porosity, thereby ensuring suitably sufficient gas flow, and configure a portion of the catalyst layer adjacent to the ion exchange layer to have high density of the ionomer binder, by which a property of interface contact is enhanced, thereby ensuring fluid movement of hydrogen ions.

Accordingly, compared with a catalyst layer having uniformly distributed ionomer binder therein, a catalyst layer in which the density of the ionomer binder is suitably biased to the ion exchange layer, enhances the performance of the MEA.

The method of manufacturing the catalyst layer 4 may be selected from various conventional methods such as, but not limited to, spray coating, bar coating, slot die and so on. As illustrated in FIG. 2, in the catalyst layer 4 manufactured by the conventional method, the contents ratio of the ionomer binder and the catalyst carried by carbon may be variable, but the distribution profile of two materials is not considerably changeable.

In certain examples where the distribution of the ionomer binder is considerably uniform throughout the entire of the catalyst layer, fuel supply at the catalyst layer interface 1 cannot be performed in a suitably smooth manner, and transfer of protons generated in the catalyst layer 4 to an anode via the ion exchange layer 3 may be hindered by an interface resistance caused by decrease of interface adhesive force, thus decreasing the overall performance of MEA.

As illustrated in FIG. 2, the catalyst layer 4 manufactured by the conventional method shows suitably uniform distribution of the ionomer binder and the catalyst.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides a method of manufacturing a catalyst layer for an MEA, in which ionomer binder and catalysts are suitably distributed in a considerably biased manner.

In a preferred aspect, the present invention provides a method for manufacturing a catalyst layer of MEA including catalysts and ionomer binder whose densities are suitably different from each other, the method preferably comprising: forming a catalyst slurry by mixing the catalysts, the ionomer binder and solvent; separating the catalysts and the ionomer binder, the separating preferably being performed by rotating the catalyst slurry to apply centrifugal force; evaporating the solvent in the catalyst slurry, which is a suitably separated state of the catalyst and the ionomer binder, to form as a suitably solid state; and then preferably drying the catalyst slurry, whereby the catalysts and the ionomer binder are suitably distributed in the catalyst layer in a substantially separated manner.

In another preferred embodiment, the catalyst slurry includes about 20 to 25 weight % of a mixture of the catalyst and the ionomer binder, and about 75 to 80 weight % of the solvent.

In another preferred embodiment, the solvent is selected from a group consisting of, but not limited to, water, isopropyl alcohol, propyl alcohol, ethanol, and combinations thereof.

In still another preferred embodiment, the step of drying is conducted at a temperature of about 80 to 120° C., for about 6 to 8 hours.

As described above, according to the present invention, a method for manufacturing a catalyst layer of MEA preferably manufactures the catalyst layer by suitably distributing ionomer binder differently to suitably improve performance of the MEA.

According to the instant invention, by suitably changing the distribution of the ionomer binder at the catalyst layer, transfer of hydrogen gas passing through catalyst layer interface becomes easier, and hydrogen ion generated at the catalyst layer passes through the ion exchange layer interface in a considerably smooth manner. Thus, substance transfer is improved, and, accordingly, the performance of the MEA is improved.

Moreover, according the invention as described herein, the transfer of fuel substances of the fuel cell and the transfer efficiency of hydrogen ion are suitably increased.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram illustrating a structure of a conventional fuel cell membrane electrode assembly (“MEA”);

FIG. 2 is a schematic diagram illustrating a structure of a catalyst layer of an MEA manufactured by a conventional method for manufacturing a catalyst layer;

FIG. 3 is a schematic diagram illustrating a manufacturing process of a catalyst layer using a centrifuge in accordance with an embodiment of the present invention; and

FIGS. 4 and 5 are schematic diagrams illustrating a structure of a catalyst layer manufactured by a centrifugation in accordance with an embodiment of the present invention.

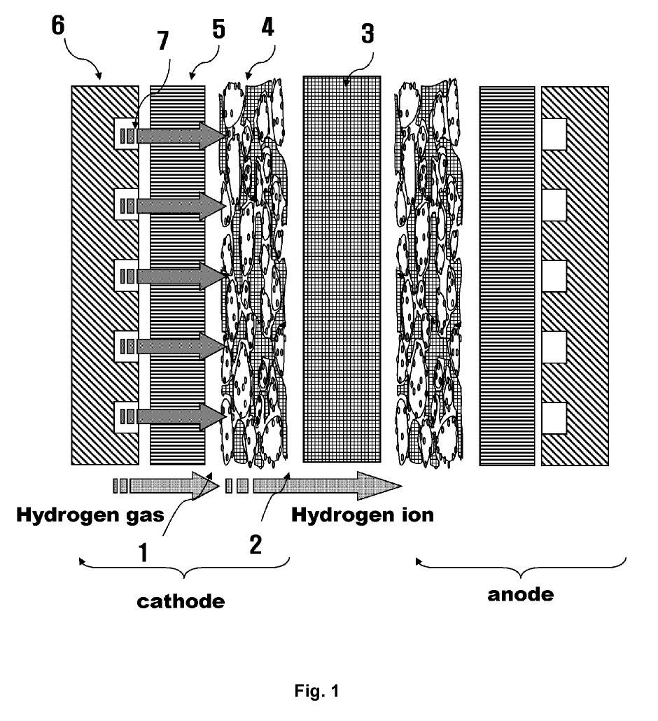

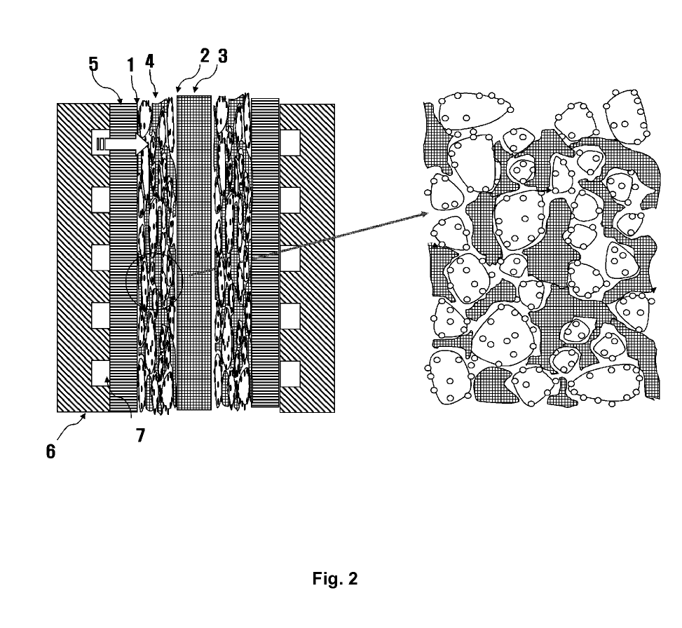

Reference numerals set forth in the Drawings includes reference to the following elements as further discussed below:

1: catalyst layer interface

2: Ion exchange membrane interface

3: Ion exchange membrane

4: catalyst layer

5: gas diffusion layer

6: separate plate

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the Figures, reference numbers refer to the same or equivalent parts of the present invention throughout the several figures of the drawing.

### DETAILED DESCRIPTION

As described herein, the present invention includes a method for manufacturing a catalyst layer of membrane electrode assembly (“MEA”) including one or more catalysts and an ionomer binder, where the densities of the catalysts and the ionomer binder are different from each other, the method preferably comprising forming a catalyst slurry by mixing the one or more catalysts, the ionomer binder and a solvent, separating the catalysts and the ionomer binder in the catalyst slurry, evaporating the solvent in the catalyst slurry, and drying the catalyst slurry, wherein the catalysts and the ionomer binder are distributed in the catalyst layer in a substantially separated manner.

In one embodiment, the separating is performed by rotating the catalyst slurry to apply centrifugal force. In another embodiment, the catalysts and the ionomer binder are separated from the solvent. In a preferred embodiment, the step of evaporating the solvent in the catalyst slurry separates the catalyst and the ionomer binder to form as solid state. In a further preferred embodiment, the catalyst slurry includes about 10, 11, 12, 13, 14, 15, 16, 17, 18, 19, 20, 21, 22, 23, 24, 25, 26, 27, 28, 29, 30 weight %, preferably 20 to 25 weight % of a mixture of the catalyst and the ionomer binder, and about 65, 66, 67, 68, 69, 70, 71, 72, 73, 74, 75, 76, 77, 78, 79, 80, 81, 82, 83, 84, 85 weight %, preferably 75 to 80 weight % of the solvent.

In other preferred embodiments, the solvent is selected from, but not limited to, the group consisting of water, isopropyl alcohol, propyl alcohol, and ethanol, and combinations thereof.

In further embodiments, the step of drying is conducted at a temperature of about 70-140° C., preferably 80 to 120° C.

In other preferred embodiment, the step of drying is conducted for a time between 4, 5, 6, 7, 8, 9, 10 or more hours, preferably 6 to 8 hours.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

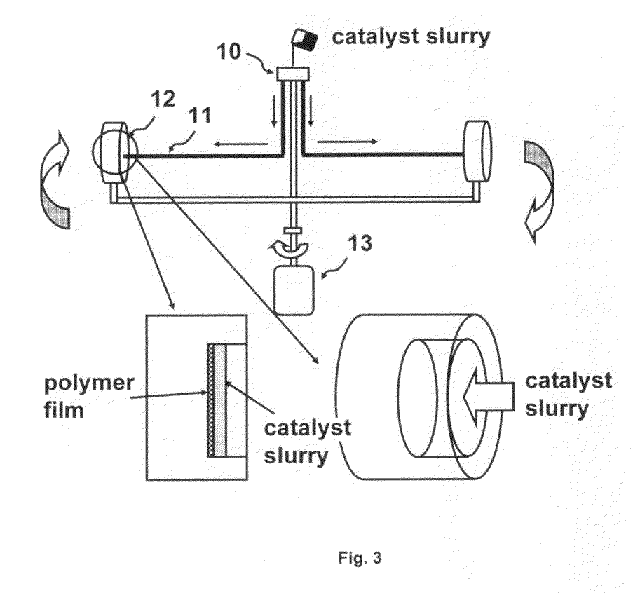

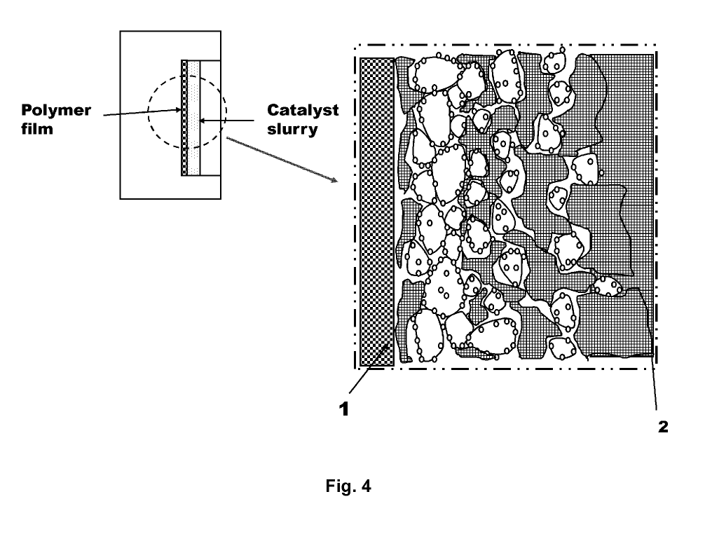

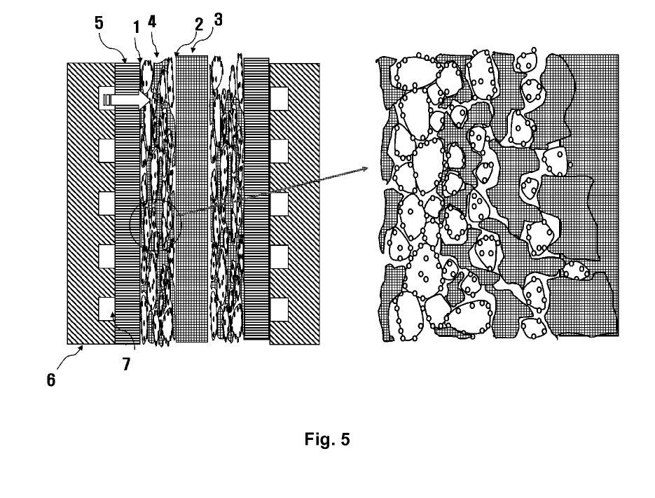

FIG. 3 is a schematic diagram illustrating an exemplary manufacturing process of a catalyst layer using a centrifuge in accordance with a preferred embodiment of the present invention. FIGS. 4 and 5 are schematic diagrams illustrating an exemplary structure of a catalyst layer manufactured by centrifugation in accordance with another preferred embodiment of the present invention.

According to preferred methods for manufacturing the catalyst layer of the MEA of the present invention, ionomer binder is more sparsely distributed adjacent to a catalyst layer interface, and more dense adjacent to an ion exchange layer interface. Preferably, by suitably varying the distribution densities of the catalysts and the ionomer binder along a direction of thickness of the catalyst layer, the performance of the MEA is suitably improved.

As illustrated in FIG. 5, the distribution of the ionomer binder adjacent to the catalyst layer interface 1 where the catalyst layer 4 and a gas diffusion layer 5 contact, is more sparse than that adjacent to the ion exchange layer interface 2 where the catalyst layer 4 and the ion exchange layer 3 suitably make contact. Preferably, such an arrangement preferably facilitates fuel supply to the catalyst layer 4 and, accordingly, ultimately enhances substance transfer.

Preferably, when the distribution of the ionomer binder at the ion exchange layer interface 2 is suitably more than at the catalyst layer interface 1, hydrogen ions, which are preferably generated when hydrogen gas passes through the catalyst, are suitably transferred to the ion exchange layer 3 through the ionomer binder, and transfer in an interface direction of both poles is suitably improved. Thus, in preferred embodiments, an adhesive force at the catalyst layer interface 1 is suitably increased, and an interface resistance is suitably decreased, so that the performance of the MEA improves.

In certain preferred embodiments, catalyst slurry, which is used to form the catalyst layer 4, mainly comprises catalyst carried by carbon and ionomer binder. Any conventional catalyst carriers other than carbon may be used. In further related embodiments, the density of the carbon and the ionomer binder is substantially the same, for example about 1, 1.25, 1.5, 1.75, 2, 2.25, 2.5 g/cm², preferably about 2 g/cm². In other related embodiments, the density of the catalyst attached to the carbon is very high, for example about 20, 20.25, 20.5, 20.75, 21, 21.25, 21.5, 21.75, or 22 g/cm², preferably about 21.5 g/cm².

In preferred examples, the catalyst and the ionomer binder, which are considerably different in the density, are rotated at high-speed. Thus in further related embodiments, the distribution of the catalyst having carbon, which has a greater density, is suitably increased at an outside of the axis. The distribution of the ionomer binder, which has a smaller density, is suitably increased at an inside of the axis, accordingly, in further related embodiments, the layers separating.

In other embodiments, order to distribute the catalyst and the ionomer binder differently at the catalyst layer interface 1 and the ion exchange layer interface 2, a centrifuge is preferably used as illustrated in FIG. 3.

In certain exemplary embodiments, the centrifuge includes a beaker 10 supplying the catalyst slurry, a motor 13 connected to the beaker 10 and supplying rotation driving force, and a transfer tube 11 connected between the beaker 10 and a separating basket.

In further exemplary embodiments, when the motor 13 starts to rotate the beaker 10, a small dose of the catalyst slurry including the catalyst and the ionomer binder is preferably inputted to the beaker 10.

The catalyst slurry is manufactured to include about 20 to 25 weight % of the catalyst and the ionomer binder, and about 75 to 80 weight % of the solvent.

Preferably, the catalyst and the ionomer binder are mixed as a common ratio, and the substance used as the solvent may be selected from, but not limited to, one from a group consisting of water, isopropyl alcohol, propyl alcohol and ethanol or the mixture of two more selected from the group. The substance evaporated quickly may be advantageous at processes.

In further embodiments, the catalyst slurry is moved to the separate basket via the transfer tube 11 by the centrifugal force, and the beaker 10 is preferably rotated at low-speed to suitably transfer the catalyst slurry to the separate basket 12 smoothly.

In further embodiments of the invention, the rotation speed is between 40-60 RPM, preferably 50 RPM at minimum until the catalyst slurry at the beaker 10 moves to the separate basket 12 completely, and the rotation speed is suitably increased after the catalyst slurry moves to the separate basket 12 completely or considerably completely to distribute the catalyst and the ionomer binder differently.

Preferably, the separate basket 12 is rotated at considerably high-speed to make the centrifugal force larger. As illustrated in FIG. 4, the catalyst having a suitably large density moves in an outside direction by the centrifugal force, and the ionomer binder having suitably smaller density moves in a center direction, and accordingly the distribution is suitably diverged.

Preferably, the solvent is evaporated to make a solid state. In related embodiments, the solvent is evaporated during about one hour to make as solid state, which is preferably not mobile. In further embodiments, the catalyst layer as the solid state is taken out and is inputted to the drying oven, and is dried at the temperature of about 80 to 120° C. and during, but not limited to a time of about 6 to 8 hours, to remove the solvent almost completely or completely.

Preferably, in order to adjust the shape of the catalyst layer, the amount of the catalyst slurry, which is inputted to the beaker 10 at the initial process, and the size and the shape of the separate basket 12 may be suitably adjusted to adjust the shape and the size of the catalyst layer 4.

FIG. 4 is an exemplary catalyst layer manufactured by the method as set forth above, a left part is the catalyst layer interface 1, and a right part is substantially the same as the ion exchange layer interface 2.

Preferably, in the catalyst layer manufactured by the method of the present invention, the amount (weight %) of ionomer binder at the catalyst layer interface 1 is low, for example preferably as about 20 to 30 weight % of the total content of the ionomer binder, and the fuel gas is supplied smoothly, and the substance transfer resistance is suitably reduced. The amount (weight %) of ionomer binder at the ion exchange layer interface 2 is high, as about 70 to 80 weight % of the total content of the ionomer binder, and the hydrogen ion generated at the catalyst layer moves smoothly, and the interface substance transfer resistance is suitably reduced, and the transfer resistance of the ion exchange layer interface 2 is reduced. Thus, the MEA having high performance may be manufactured.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a catalyst layer of membrane electrode assembly (“MEA”) including catalysts and ionomer binder whose densities are different from each other, the method comprising:
forming catalyst slurry by mixing the catalysts, the ionomer binder and solvent;
separating the catalysts and the ionomer binder by rotating the catalyst slurry to apply centrifugal force;
evaporating the solvent in the catalyst slurry, which is separated state of the catalyst and the ionomer binder, to form as solid state; and
drying the catalyst slurry, whereby the catalysts and the ionomer binder are distributed in the catalyst layer in a substantially separated manner.

2. The method for manufacturing the catalyst layer of the MEA of claim 1,
wherein the catalyst slurry includes about 20 to 25 weight % of a mixture of the catalyst and the ionomer binder, and about 75 to 80 weight % of the solvent.

3. The method for manufacturing the catalyst layer of the MEA of claim 1,
wherein the solvent is selected from a group of water, isopropyl alcohol, propyl alcohol, ethanol, and combination thereof.

4. The method for manufacturing the catalyst layer of the MEA of claim 1,
wherein the step of drying is conducted at a temperature of about 80 to 120° C. for about 6 to 8 hours.

5. A method for manufacturing a catalyst layer of membrane electrode assembly (“MEA”) including one or more catalysts and an ionomer binder whose densities are different from each other, the method comprising:
forming a catalyst slurry by mixing the one or more catalysts, the ionomer binder and a solvent;
separating the catalysts and the ionomer binder in the catalyst slurry;
evaporating the solvent in the catalyst slurry; and
drying the catalyst slurry, wherein the catalysts and the ionomer binder are distributed in the catalyst layer in a substantially separated manner.

6. The method of claim 5, wherein the separating is performed by rotating the catalyst slurry to apply centrifugal force.

7. The method of claim 5, wherein the catalysts and the ionomer binder are separated from the solvent.

8. The method of claim 5, wherein the step of evaporating the solvent in the catalyst slurry separates the catalyst and the ionomer binder to form as solid state.

9. The method of claim 5, wherein the catalyst slurry includes about 20 to 25 weight % of a mixture of the catalyst and the ionomer binder, and about 75 to 80 weight % of the solvent.

10. The method of claim 5, wherein the solvent is selected from the group consisting of: water, isopropyl alcohol, propyl alcohol, and ethanol, and combinations thereof.

11. The method of claim 5, wherein the step of drying is conducted at a temperature of about 80 to 120° C.

12. The method of claim 5, wherein the step of drying is conducted for a time between 6 to 8 hours.
